(19) United States
(12) Patent Application Publication
(10) Pub. No.: US 2023/0123824 A1
(43) Pub. Date: Apr. 20, 2023

(54) TIRE COMPRISING A TREAD OPTIMIZED FOR GRIP ON SNOW-COVERED GROUND

(71) Applicant: COMPAGNIE GENERALE DES ETABLISSEMENTS MICHELIN, Clermont-Ferrand (FR)

(72) Inventor: BERTRAND BOISDON, Clermont-Ferrand (FR)

(21) Appl. No.: 17/914,624

(22) PCT Filed: Mar. 23, 2021
(86) PCT No.: PCT/FR2021/050488

§ 371 Date: Sep. 26, 2022

(30) Foreign Application Priority Data
Mar. 26, 2020 (FR) FR2002960

(51) Int. Cl. B60C 11/03; B60C 11/12; B60C 11/13

(52) U.S. Cl. CPC B60C 11/0318; B60C 11/1259; B60C 11/0302; B60C 11/1392; B60C 11/033; B60C 2011/1295

(57) ABSTRACT

A tire has a tread comprising at least two tread pattern elements (MA, MB) distributed periodically in the circumferential direction at pitches (PA, PB). Each tread pattern element is formed of three portions (Z1, Z2, Z3), each defining a volumetric element of which the leading edge corner is the one common to the tread surface and is the first to enter the contact patch in which the tire is in contact with the ground. With each leading edge corner being chamfered, in the portions Z1 and/or Z2, and/or Z3, the widths of the chamfers of the leading edge corners (LCᵢ^{A}, LCᵢ^{B}, i ranging from 1 to 3) satisfy the following inequalities: a) for the portion Z1:

$$[ [ ] ] 0.8 * \frac{P A}{P B} \leq \frac{L {C}_{1}^{A}}{L {C}_{1}^{B}} \leq \frac{P A}{P B} * 1.2 ;$$

b) for the portion Z2:

$$[ [ ] ] 0.8 * \frac{P A}{P B} \leq \frac{L {C}_{2}^{A}}{L {C}_{2}^{B}} \leq \frac{P A}{P B} * 1.2 ;$$

and c) for the portion Z3:

$$[ [ ] ] 0.8 * \frac{P A}{P B} \leq \frac{L {C}_{3}^{A}}{L {C}_{3}^{B}} \leq \frac{P A}{P B} * 1.2 .$$

Moreover, the sipes density of each tread pattern element (SDA, SDB) is at least equal to 10 mm⁻¹ and at most equal to 70 mm⁻¹.

### TECHNICAL FIELD

The present invention relates to a tyre for a motor vehicle known as an “all-season” tyre. The invention is more particularly suited to a radial tyre intended to be fitted to a passenger vehicle or van.

### Definitions

In the following text, the circumferential, axial and radial directions refer to a direction tangential to any circle centred on the axis of rotation of the tyre, to a direction parallel to the axis of rotation of the tyre, and to a direction perpendicular to the axis of rotation of the tyre, respectively.

By convention, in a frame of reference (O, XX′, YY′, ZZ′), the centre O of which coincides with the centre of the tyre, the circumferential direction XX′, axial direction YY′ and radial direction ZZ′ refer to a direction tangential to the tread surface of the tyre in the direction of rotation, to a direction parallel to the axis of rotation of the tyre, and to a direction orthogonal to the axis of rotation of the tyre, respectively.

Radially inner and radially outer mean closer to and further away from the axis of rotation of the tyre, respectively.

Axially inner and axially outer mean closer to and further away from the equatorial plane of the tyre, respectively, the equatorial plane of the tyre being the plane that passes through the middle of the tread of the tyre and is perpendicular to the axis of rotation of the tyre.

A tyre comprises a crown intended to come into contact with the ground via a tread, the two axial ends of which are connected via two sidewalls to two beads that provide the mechanical connection between the tyre and the rim on which it is intended to be mounted.

Generally, those skilled in the art define the tread of a tyre mainly with the aid of the following design features: the tread surface, which makes it possible to define the total width of the tread, and the tread pattern, which is characterized by a volumetric void ratio.

The “tread surface” of a tread means the surface that groups together all the points of the tyre that will come into contact with the ground under normal running conditions. These points that will come into contact with the ground belong to the contact faces of the blocks. For a tyre, the “normal running conditions” are the use conditions defined by the ETRTO (European Tyre and Rim Technical Organisation) standard. These use conditions specify the reference inflation pressure corresponding to the load-bearing capacity of the tyre as indicated by its load index and its speed rating. These use conditions can also be referred to as “nominal conditions” or “working conditions”.

The total width of the tread is the axial distance between the axial ends of the tread surface, these being symmetric with respect to the equatorial plane of the tyre. From a practical standpoint, an axial end of the tread surface does not necessarily correspond to a point that is clearly defined. In the knowledge that the tread is delimited externally, on the one hand, by the tread surface and, on the other hand, by two surfaces where it meets two sidewalls that connect said tread to two beads intended to provide the connection to a mounting rim, an axial end can therefore be defined mathematically as being the orthogonal projection, onto the tread, of a theoretical point of intersection between the tangent to the tread surface in the axial end zone of the tread surface and the tangent to the connecting surface in the radially outer end zone of the connecting surface. The total width of the tread corresponds substantially to the axial width of the contact surface when the tyre is subjected to the recommended load and pressure conditions.

The tread is generally made up of the repetition of raised volumetric elements known as tread pattern elements in the circumferential direction, which are separated from one another by cuts. The tread pattern elements that are more particularly taken into account in the context of the invention are organized in at least two circumferential rows that are symmetric with respect to the equatorial plane passing through the centre of the tread, and are then offset angularly by rotation of one row with respect to the other about the axis of rotation of the tyre.

Each tread pattern element therefore comprises two half-elements that are symmetric with respect to the equatorial plane and offset by a distance of about 12 mm to 17 mm in the circumferential direction. Each tread pattern half-element extends axially between an edge of the tread and the centre of the tread with a curve in the axial direction, the orientation of which determines the direction of rotation of the tyre. Associated with this element is a repeat pitch, known as the element pitch.

The pitch of a tread pattern element is the distance measured around a circumference of the tyre between a point of this element and the translated image of this point onto the immediately following element.

A tread with a single tread pattern element is known as a mono-pitch tread. However, in general, the tread of a tyre for a passenger vehicle is generally made up of a circumferential distribution of two or three tread pattern elements with a pitch length of between 20 mm and 40 mm.

The tread pattern elements of the tread are notched by cuts which may be grooves, sipes or “V-grooves”.

A “groove” is understood to be a cut or void in which the distance between the walls of material that delimit said groove is greater than 2 mm and the depth of which is less than or equal to 1 mm.

A “sipe” is understood to be a cut or void in which the distance between the walls of material that delimit said sipe is less than or equal to 2 mm and the depth of which is greater than or equal to 1 mm.

The sipes density SD corresponds the ratio between a sum of the projected lengths (lpyi) of the sipes along an axial direction (Y) to the product of the pitch P of the tread pattern element and the width (W) of the tread, the whole being multiplied by 1000, such that

$$S D = \frac{{\sum }_{i = 1}^{n} lpyi}{P * W} * 1000 ,$$

where n is the number of sipes in the tread pattern element and lpyi is the projected length of the i-th sipe.

For the “all-season” tyres considered by the invention, in the new state, the sipes density SD in each of the tread pattern elements is at least equal to 10 mm⁻¹ and at most equal to 70 mm⁻¹.

The other types of cuts, generally known as “V-grooves” are voids with a depth less than 1 mm.

The volumetric void ratio of the tread is defined as being the ratio between the total volume of the grooves separating the raised elements and the total volume of the tread assumed to be free of voids, which is radially comprised between the bottom surface and the tread surface. The bottom surface is defined as being the surface translated from the tread surface radially towards the inside over a radial distance corresponding to the maximum radial depth of the grooves, referred to as the radial height Hmax of the tread. The volumetric void ratio thus implicitly defines the volume of elastomer material of which the tread is made that is intended to be worn away. It also has a direct impact on the contact patch in which the tread is in contact with the ground and, therefore, on the contact pressures for contact with the ground, both of which govern tyre wear.

Each tread pattern element is a raised volumetric element having a leading face which is the face that is the first to enter the contact patch in which the tyre is in contact with the ground. The edge corner of the radially outer leading face is referred to as leading edge corner below. Each element also comprises a trailing face, which is the face of which the radially outer edge corner is the last to leave the contact patch in which the tyre is in contact with the ground, said edge corner of the radially outer trailing face being known as the trailing edge corner below.

The edge corner is said to be chamfered if it comprises a chamfer, in other words, the edge corner has an appearance as if it had been planed down in order to be replaced by a rectangular flat surface that is therefore positioned between the contact face of the tread surface and one of the adjacent faces of the volumetric element in question.

An edge corner chamfer is therefore a connecting surface that is usually flat and inclined in the direction of the void in front of the tread pattern element in the running direction of the tyre.

The choice of the material of which the tread is made is a step that is essential to the design of a tyre. Generally, it is an elastomeric material characterized by its dynamic properties, such as its glass transition temperature and/or its complex dynamic shear modulus G*.

The glass transition temperature is a normal physical characteristic of an elastomeric material, which corresponds to the temperature at which the material passes from a rubbery state to a rigid glassy state.

The glass transition temperature Tg of an elastomeric compound is generally determined during the measurement of the dynamic properties of the elastomeric compound, on a viscosity analyser (Metravib VA4000), according to the standard ASTM D 5992-96. The dynamic properties are measured on a sample of vulcanized elastomeric compound, that is to say elastomeric compound that has been cured to a degree of conversion of at least 90%, the sample having the form of a cylindrical test specimen having a thickness equal to 2 mm and a cross-sectional area equal to 78.5 mm². The response of the sample of elastomeric compound to a simple alternating sinusoidal shear stress, having a peak-to-peak amplitude equal to 0.7 MPa and a frequency equal to 10 Hz, is recorded. A temperature sweep is carried out at a constant rate of rise in temperature of +1.5° C./min. The results utilized are generally the complex dynamic shear modulus G*, comprising an elastic part G′ and a viscous part G″, and the dynamic loss tgδ equal to the ratio G″/G′. The glass transition temperature Tg is the temperature at which the dynamic loss tgδ reaches a maximum during the temperature sweep. The value of G* measured at 60° C. is indicative of the stiffness of the rubbery material, that is to say of its resistance to elastic deformation.

### PRIOR ART

As is known, a tyre known as an “all-season” tyre, for a passenger vehicle, is a tyre which affords a compromise between grip on snowy ground and on wet ground while still maintaining good performance on dry ground. These tyres are intended to run safely all year round, whatever the weather. They have generally attained the 3PMSF (Peaks Mountain Snow Flake) winter regulatory certification, according to the regulations relating to the safety of tyres such as the UNECE (United Nations Economic Commission for Europe) regulations R30 and R117, attesting to their good performance in terms of grip on snowy ground and on wet ground. This certification is notably indicated on one or both of the sidewalls of this type of tyre.

The document WO2016/134988 discloses an “all-season” tyre having a tread that has two edges and a centre. Said tread is directional and has a plurality of tread pattern elements made of rubbery material. More particularly, each tread pattern element has a central zone extending overall at an angle β1, said angle β1 being at least greater than 35 degrees and at most less than 65 degrees to an axial direction. Each tread pattern element also has an edge zone extending overall at an angle β3 at least greater than 0 degrees and at most less than 10 degrees to said axial direction. Lastly, each tread pattern element has a junction zone between the central zone and the edge zone of the element, said junction zone making an angle β2 with said axial direction.

The document WO2019/123277 discloses an “all-season” tyre that also has a plurality of tread pattern elements. Each tread pattern element comprises three portions that are separated by oblique grooves and form a portion block, a central block and an intermediate block between the edge portion and the central portion. Only the edge portion comprises a chamfer positioned on a leading face of this edge portion.

There is an ever-present need to improve the performance of “all-season” tyres both with regard to the compromise between grip on dry ground, grip on snowy ground and grip on wet ground and in terms of running noise.

The inventors set themselves the objective of improving the compromise relating to grip on snowy ground without impairing the other performance aspects such as grip on wet ground, grip on dry ground, and running noise for an “all-season” tyre, essentially for passenger vehicles and vans.

### SUMMARY OF THE INVENTION

This aim has been achieved according to the invention by a tyre having a tread intended to come into contact with the ground via a tread surface:
the tread comprising raised elements that are organized in tread pattern elements (MA, MB), are separated from one another at least in part by grooves and extend radially towards the outside from a bottom surface as far as the tread surface over a radial height H at least equal to 6 mm and at most equal to the radial height Hmax of the tread;
each tread pattern element (MA, MB) comprising two parts, known as half-elements (MA1, MA2) and (MB1, MB2), which are symmetric with respect to the equatorial plane passing through the centre of the tread (C) and are offset from one another in the circumferential direction by a distance D;
each half-element (MA1, MB2) and their respective symmetric counterpart (MA2, MB2) being curved, in an axial direction (YY′), from an axial end of one edge (24G, 24D) of the tread to the centre (C) of the tread (10) so as to defined a preferred direction of running of the tyre, and having an axial width (L);
each half-element (MA1, MB1; MA2, MB2) comprising a first, lateral portion (Z3) extending from an axial end of the edge (24G, 24D) of the tread over an axial width equal to at most one third of the axial width (L) of the half-element, a second, central portion (Z1) having the same axial width as the first, lateral portion (Z3), and a third, intermediate portion (Z2) contiguous with the two other portions;
each portion (Z1, Z2, Z3) of each half-element (MA1, MB1; MA2, MB2) being a volumetric element having a leading face, which is the face of which the radially outer edge corner is the first to enter the contact patch in which the tyre is in contact with the ground, said edge corner of the radially outer leading face being known as the leading edge corner below;
each portion (Z1, Z2, Z3) of each half-element (MA1, MB1; MA2, MB2) having a trailing face, which is the face of which the radially outer edge corner is the last to leave the contact patch in which the tyre is in contact with the ground, said edge corner of the radially outer trailing face being known as the trailing edge corner below;
the leading edge corners of each portion (Z1, Z2, Z3) respectively having a chamfered profile (51, 52, 53), with respective widths of the chamfers (LC₁^{A}, LC₂^{A}, LC₃^{A}) for the half-elements (MA1, MA2) of a first element and, respectively, (LC₁^{B}, LC₂^{B}, LC₃^{B}) for the half-elements (MB1, MB2) of a second element;
the width of a chamfer in a portion (Z1, Z2, Z3) being the normal distance between the leading face of the portion and the edge corner of the chamfer belonging to the tread surface;
the tread being obtained through a periodic distribution in the circumferential direction of a first tread pattern element MA formed of the first half element MA1 and of its symmetric counterpart MA2 at a pitch PA, and of a second tread pattern element MB formed of the second half element MB1 and of its symmetric counterpart MB2 at a pitch PB, where PA<PB;
a “sipe” being a cut or void in which the distance between the walls of material that delimit said sipe is less than or equal to 2 mm and the depth of which is greater than or equal to 1 mm, the sipes density of the tread pattern elements SD corresponding to the ratio between the sum of the projected lengths (lpyi) of the sipes of a tread pattern element (MA, MB) along an axial direction (Y) to the product of the pitch (PA, PB) of the tread pattern element and the width (W) of the tread, the whole being multiplied by 1000, such that

$$SDA = \frac{{\sum }_{i = 1}^{nay} lpyi}{PA * W} * 1000 , and SDB = \frac{{\sum }_{i = 1}^{nby} lpyi}{PB * W} * 1000$$

where nay and nby are the number of sipes of each tread pattern element (MA, MB) and lpyi is the projected length of the i-th sipe of the element in question,
in the portions Z1 and/or Z2, and/or Z3, the widths of the chamfers of the leading edge corners (LCᵢ^{A}, LCᵢ^{B}) (i ranging from 1 to 3) of the half-elements (MA1, MA2) and (MB1, MB2) with respective pitches (PA, PB) satisfy the following inequalities:
   a) for the portion Z1:

$$0.8 * \frac{PA}{PB} \leq \frac{{LC}_{1}^{A}}{{LC}_{1}^{B}} \leq \frac{PA}{PB} * 1.2$$

b) for the portion Z2:

$$0.8 * \frac{PA}{PB} \leq \frac{{LC}_{2}^{A}}{{LC}_{2}^{B}} \leq \frac{PA}{PB} * 1.2$$

c) for the portion Z3

$$0.8 * \frac{PA}{PB} \leq \frac{{LC}_{3}^{A}}{{LC}_{3}^{B}} \leq \frac{PA}{PB} * 1.2 ,$$

the sipes density of each tread pattern element (SDA, SDB) is at least equal to 10 mm⁻¹ and at most equal to 70 mm⁻¹.

The principle of the invention is to chamfer the leading edge corners of the elements of the tread pattern of the tread which is formed by the circumferential distribution of at least two patterns MA and MB at respective pitches (PA, PB). The invention establishes the correlation between the tread pattern pitches and the widths of chamfers of the leading edge corners of the tread pattern elements of the tread.

According to the invention, in the portions Z1 and/or Z2, and/or Z3, the widths of the chamfers of the leading edge corners (LCᵢ^{A}, LCᵢ^{B}, i allant de 1, à 3) of the half-elements (MA1, MA2) and (MB1, MB2) with respective pitches (PA, PB) satisfy the following inequalities:

a) for the portion Z1:

$$0.8 * \frac{PA}{PB} \leq \frac{{LC}_{1}^{A}}{{LC}_{1}^{B}} \leq \frac{PA}{PB} * 1.2$$

b) for the portion Z2:

$$0.8 * \frac{PA}{PB} \leq \frac{{LC}_{2}^{A}}{{LC}_{2}^{B}} \leq \frac{PA}{PB} * 1.2$$

c) for the portion Z3.

$$0.8 * \frac{PA}{PB} \leq \frac{{LC}_{3}^{A}}{{LC}_{3}^{B}} \leq \frac{PA}{PB} * 1.2$$

Each half-element MA1, and its symmetric counterpart with respect to the equatorial plane, MA2, of the tread pattern element MA is partitioned into three portions Z1, Z2, Z3, which have their leading edge corners chamfered, with chamfer widths (LC₁^{A}, LC₂^{A}, LC₃^{A}). In the same way, the half-elements (MB1, MB2) of the tread pattern element MB have their leading edge corners chamfered with chamfer widths (LC₁^{B}, LC₂^{B}, LC₃^{B}) in the portions Z1, Z2 and Z3.

During the designing of the tyre, the succession of the tread pattern elements (MA, MB) is determined by seeking to minimize the running noise. At the end of this step, the number of tread pattern elements MA and MB and the associated pitches (PA, PB) are determined

For the first tread pattern element MA, by setting an initial value for the width of the chamfer in a portion (Z1, Z2, Z3), on the basis of the equations (a, b, c), the possible values of the width of the chamfer of the second tread pattern element MB in the same portion in question is deduced therefrom.

For example, considering a tread with a tread pattern comprising an element MA with a pitch PA of 23.6 mm and an element MB with a pitch PA of 27.7 mm, by initializing LC₁^{A} at 1.3 mm, it will be deduced therefrom, according to inequality (a), that LC₁^{B} is in the range [1.27 mm; 1.91 mm].

Furthermore, the invention also proposes having a sufficient sipes density for each tread pattern element to arrive at the desired compromise in terms of performance for an “all-season” tyre, for the performance aspects of grip on dry ground and running noise.

Also according to the invention, the sipes density of each tread pattern element (SDA, SDB) is at least equal to 10 mm⁻¹ and at most equal to 70 mm⁻¹.

Each tread pattern element (MA, MB) comprises half-elements (MA1, MA2) and (MB1, MN2). The sipes density (SDA, SDB) is understood as being the combination of each tread pattern half-element (MA1, MA2) and (MB1, MB2).

Preferably, with the tread comprising a number (NA, NB) of tread pattern elements (MA, MB), the average sipes density SDmoy is at least equal to 10 mm⁻¹ and at most equal to 70 mm⁻¹, with the average sipes density being defined by:

$$SDmoy = \frac{SDA * NA * PA + SDB * NB * PB}{NA * PA + NB * PB} ,$$

where (SDA, SDB) are sipe densities of the tread pattern elements (MA, MB).

Each tread pattern element (MA, MB) is notched with sipes so as to obtain a density (SDA, SDB) at least equal to 10 mm⁻¹ and at most equal to 70 mm⁻¹, thereby ensuring an average sipes density per wheel revolution in the same interval.

For grip on wet ground, the sipes densities (SDA, SDB) of the tread pattern elements promote the bending movement of the tread pattern elements and thus brings about overpressures at the leading edge. The sipes densities (SDA, SDB) for each of the tread pattern elements (MA, MB), which are equal to at least 10 mm⁻¹ and at most equal to 70 mm⁻¹, make it possible to arrive at the desired compromise between the performance aspects of grip on dry ground and grip on wet ground.

The invention also proposes a compromise between the performance aspect of running noise and the performance aspect of grip on snowy or wet ground, where the geometry of the chamfers is defined in a manner correlated with the elements of the tread pattern.

There are two major types of feature which are caused by the impact of the tread pattern elements on the roadway: whining and beating. These are features of which the acoustic power is much greater than the mean power of the spectrum and to which the human ear is particularly sensitive.

The timing of the impacts of the tread pattern on the ground on entering the contact patch is given its pattern by the order of succession of the elements. If the elements are all the same size, they follow one another with a perfectly regular rhythm. A single frequency will then be brought about, and this will produce a “whine”-like sound. Having several sizes of element makes it possible to scramble the sound signal emitted by the tread pattern of the tyre, that is to say to reduce the features, so as to tend towards white noise.

The succession of the elements of the tread is designed so as to attenuate whining and beating. Two elements may differ in terms of width, sipes density and/or the associated pitch.

Preferably, the ratio between the pitch PA of the first tread pattern element MA formed of the half-elements (MA1, MA2) divided by the pitch PB of the second tread pattern element MB formed of the half-elements (MB1, MB2), PA/PB, is at least equal to 0.60 and at most equal to 0.90.

Also preferably, the ratio between the pitch PA of the first tread pattern element MA formed of the half-elements (MA1, MA2) divided by the pitch PB of the second tread pattern element MB formed of the half-elements (MB1, MB2), PA/PB, is at least equal to 0.85.

The ratio PA/PB of the shortest pitch PA of the first tread pattern element divided by the longest pitch PB of the second tread pattern element is in the range [0.6; 0.9]. The smallest pitch and the longest pitch are in a ratio ideally equal to 0.85, or at least included in the range [0.6; 0.9].

When the pitch ratio is less than 0.6, the difference between the two pitches becomes too large and causes an excessive discontinuity of the arrangement of the tread pattern elements over one revolution of the wheel.

Conversely, for a pitch ratio above 0.9, the distance between tread pattern elements becomes too small, and the tread pattern of the tread gets close to a mono-pitch solution, which is not satisfactory as regards the level of noise generated.

Advantageously, the widths of the chamfers of the leading edge corners (LC₁^{A}, LC₂^{A}, LC₃^{A}) for the first tread pattern element MA formed of the half-elements (MA1, MA2) and (LC₁^{B}, LC₂^{B}, LC₃^{B}) for the second tread pattern element MB formed of the second half-elements (MB1, MB2) of the respective portions (Z1, Z2, Z3) satisfy at least one of the following relationships:
a. LC₁^{X} belongs to the range [0.5, 2] mm, where X=A, or B
b. LC₂^{X} belongs to the range [1, 2.5] mm, where X=A or B
c. LC₃^{X} belongs to the range [1.5, 3] mm, where X=A, B.

From a practical point of view, the elements and the pitches of the tread are first of all determined by seeking to minimize the whining and beating noise. Then, the ratios of the pitches of the elements are used to determine the widths of the chamfers of the elements. This is an iterative design process which, on convergence, leads to the tyre of the invention.

Preferably, with the tread comprising a third tread pattern element MC formed of two half-elements (MC1, MC2) that are symmetric with respect to the equatorial plane (C), with a pitch PC, where PB is smaller than PC, the ratio of the pitches PB/PC is greater than or equal to the ratio of the pitches PA/PB.

The use of three tread pattern elements makes it easier to attenuate noise with more effective scrambling of the excitation signal of the tread pattern compared with a mono-pitch tread pattern or even with just two element. If there were more than three elements, the industrial manufacturing cost of the mould in the design phase and in the use phase would worsen significantly.

The inventors have found that the pitch of the third pattern is linked to the preceding pitches in a proportionality ratio.

Advantageously, the tread pattern elements have a radial height Hmax at most equal to 9 mm and preferably at most equal to 7 mm.

Advantageously, with the overall volumetric void ratio TEV corresponding to the ratio of the void volume VE to the total volume VT of the tread, such that TEV=VE/VT, the volumetric void ratio TEV of the tread is between [20%,40%], and preferably between [25%,35%].

For the performance aspect of grip, the void ratio has rack effect for promoting the grip of the tyre in the snow. This rack effect is amplified with a directional tread pattern comprising cuts. According to the inventors, an overall void ratio TEV of between [20%, 40%] and preferably between [25%, 35%] is necessary in order to have a performance of grip on snow in accordance with the invention. The volumetric void ratio also defines the volume of elastomeric material of which the tread is made that is intended to be worn away. The void ratio is therefore a sensitive parameter for determining the compromise of the performance aspects of the tyre such as wear, grip and noise.

Preferably, with the tread comprising a third tread pattern element MC with a pitch PC, the volumetric void ratio TEM of each tread pattern element (MA, MB, MC) is more or less identical.

The volumetric void ratio of a tread pattern element is defined as being the ratio between the total volume of the cuts, for example grooves, separating the raised elements and the total volume of the element that is assumed to be free of voids, which is radially comprised between the bottom surface and the tread surface.

The principle of adjusting the geometry of the tread pattern elements by way of a void ratio is to achieve a distribution of the mass of the tread that is as uniform as possible about the axis of rotation of the tyre. The dynamic unbalance or torque unbalance is a nuisance caused by non-uniformity resulting from asymmetry of mass distribution with respect to the centre of rotation of the tyre without movement of the centre of gravity. This non-uniformity creates, when the tyre is in rotation, centrifugal forces which form a torque with respect to the centre of the casing, and is the origin of a nuisance caused by lateral vibrations.

The non-uniformity in terms of mass also generates a static unbalance resulting in an asymmetry of the mass distribution of the tyre, which corresponds to eccentricity of the centre of gravity in the plane of symmetry of the tyre. The static unbalance creates, when the tyre is in rotation, a centrifugal force which is exerted on the plane of symmetry of the tyre. It brings about vertical vibrations perceived in the vehicle.

Advantageously, with the tread comprising a third tread pattern element MC with a pitch PC, the maximum pitch of the tread pattern elements out of the pitch (PA) of the first element (MA), the pitch (PB) of the second element (MB) and the pitch (PC) of the third element (MC) is between 22 mm and 40 mm, preferably between 23 mm and 36 mm.

Advantageously, the composition of the rubbery material of the tread has a glass transition temperature Tg of between −40° C. and −10° C. and preferably between −35° C. and −15° C. and a complex dynamic shear modulus G* measured at 60° C. of between 0.5 MPa and 2 MPa, and preferably between 0.7 MPa and 1.5 MPa.

The grip of the tyre on the ground obeys at least two physical phenomena: adhesion and indentation. For example, for wet ground, the tread pattern of the tread evacuates water from the ground to allow adhesion by the dry tread surface sticking to the ground. In parallel, the flexibility of the material of the tread makes it possible to conform to the irregularities of the ground by indentation in order for the tyre to grip. The material needs to remain flexible and effective at temperatures below 7° C. According to the inventors, an elastomeric material having a glass transition temperature Tg of between −40° C. and −10° C. and preferably between −35° C. and −15° C. and a complex dynamic shear modulus G* measured at 60° C. of between 0.5 MPa and 2 MPa, and preferably between 0.7 MPa and 1.5 MPa, gives the tread the appropriate physical properties to achieve the desired performance compromises.

Advantageously, at least 30% of the leading and/or trailing edge corners and preferably at least 45% of the leading and/or trailing edge corners, and more preferably 100% of the leading and/or trailing edge corners have a chamfer.

The presence of a chamfer on the leading edge corners brings about an improvement in braking on snowy ground and wet ground, but the tread may also, in some embodiments, have chamfers on the trailing edge corners, which improve grip on dry ground.

Also advantageously, with the tread comprising a number (NA, NB, NC) of tread pattern elements (MA, MB, MC), the average sipes density SDmoy is at least equal to 10 mm⁻¹ and at most equal to 70 mm⁻¹, with the average sipes density being defined by:

$$SDmoy = \frac{SDA * NA * PA + SDB * NB * PB + SDC * NC * PC}{NA * PA + NB * PB + NC * PC} ,$$

where SDC is defined as being the sipes density of the element MC of the tread pattern.

The addition of a third tread pattern element improves the running noise. However, the edge-corner density of this additional element needs to be in the established range of 10 mm⁻¹ and 70 mm⁻¹ in order to maintain the compromise in terms of grip performance aspects.

Preferably, the tyre has a 3PMSF (3 Peaks Mountain Snow Flake) certification indicated on at least one of its sidewalls.

The 3PMSF certification is granted by the government authorities of the member states of the UNECE (United Nations Economic Commission for Europe), following the successful performance of a regulatory test for grip on snow. The details of this test are defined in UNECE regulations R117 and R30 in accordance with the Geneva agreement for the approval of vehicles and the components thereof, including the tyres. The success of this test confirms the performance level of the tyre in terms of braking and traction on snow. The application of the regulatory 3PMSF marking to the sidewall of the tyre makes it possible to indicate to customers the officially tested performance level on snow.

The present invention will be understood better from reading the detailed description of embodiments that are given by way of entirely non-limiting examples and are illustrated by the appended drawings, in which:

FIG. 1 is a detail view of a half-element MA1 of the tread according to the invention and denoted by the overall reference 1-A, and then three cross-sectional views (EE, FF, GG) for illustrating the chamfers made on the trailing edge corners.

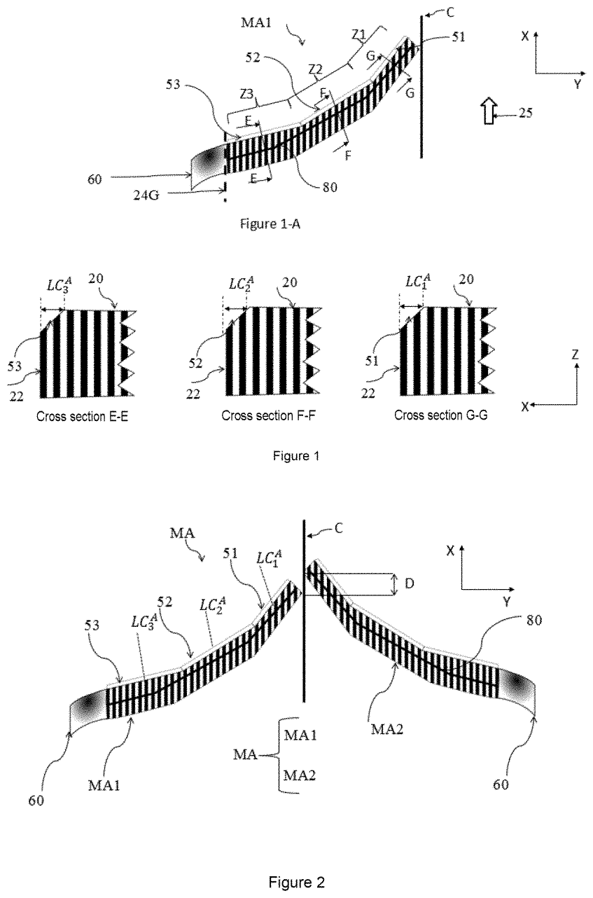

FIG. 2 shows a complete element MA of the tread pattern of the tread, formed of two half-elements MA1, MA2, which are mutually symmetric with respect to the equatorial plane (“C”) passing through the centre of the tread.

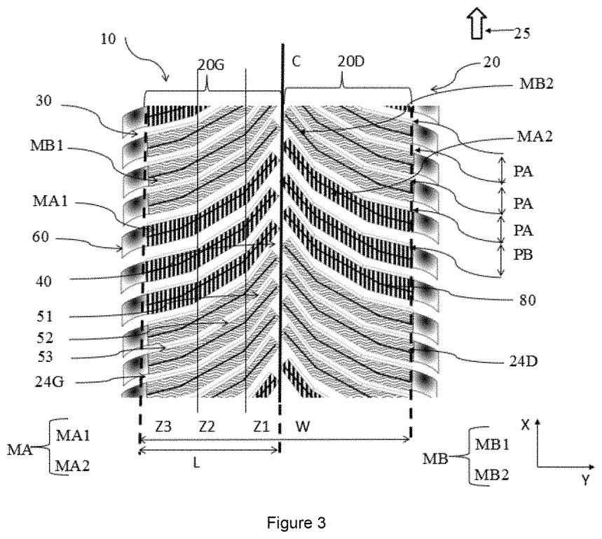

FIG. 3 shows a developed view of the tread in the circumferential direction (X) according to a first embodiment of the invention, with two tread pattern elements MA and MB. The tread pattern elements differ in terms of their geometry (widths, cuts, pitches, etc.). The element MA is depicted with vertical hatching, and the element MB with small waves.

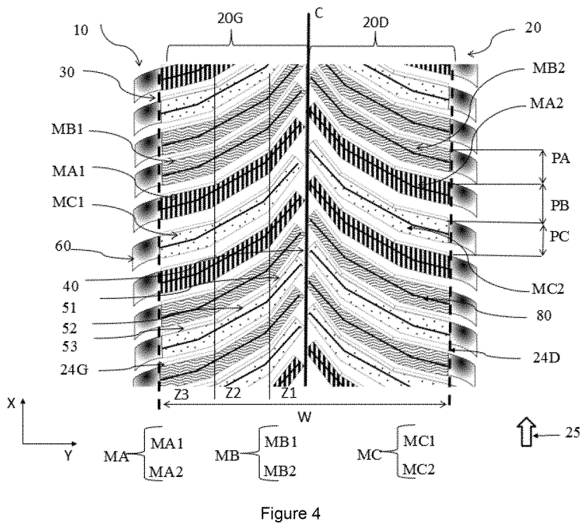

FIG. 4 shows a developed view of the tread in the circumferential direction (X) according to a second embodiment of the invention, with three tread pattern elements MA, MB and MC. The tread pattern elements differ in terms of their geometry (widths, cuts, pitches, etc.). The element MC is depicted by black dots on a white background.

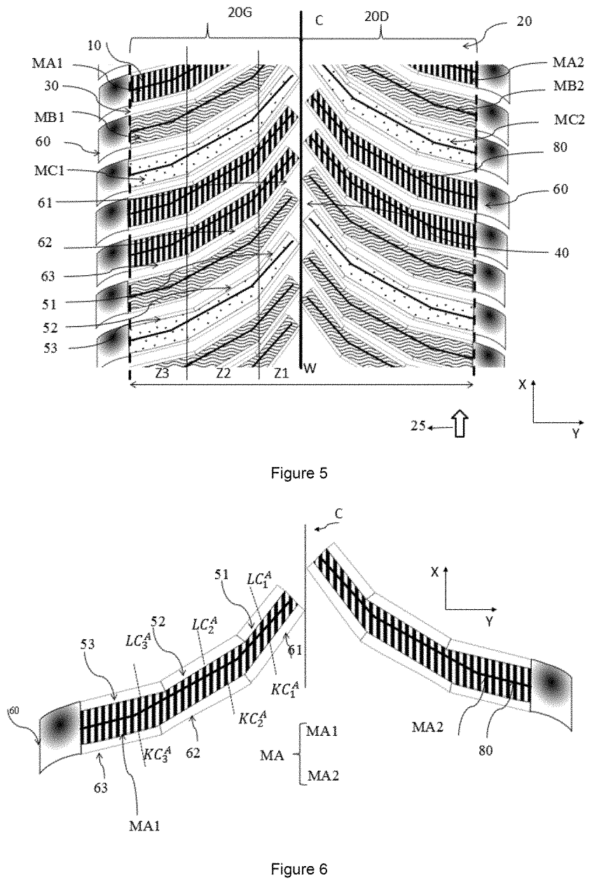

FIG. 5 is a third embodiment of the invention. It differs from FIG. 4 in that both the trailing and leading edge corners are chamfered. The chamfers of the trailing edge corners are referenced (61, 62, 63).

FIG. 6 is an extract from FIG. 5, which shows an enlargement of a tread pattern element MA (MA1, MA2) with the leading and trailing edge corners chamfered.

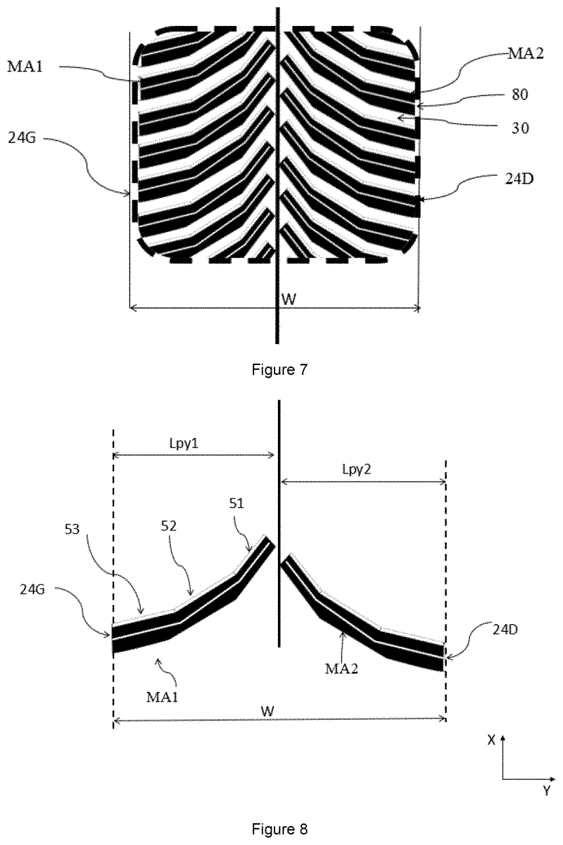

FIG. 7 shows the footprint on the ground of a tyre of the invention inflated to its nominal pressure and subjected to a vertical load.

FIG. 8 is an extract from FIG. 7 centred on a tread pattern element in the contact patch with the leading edge corners chamfered (51, 52, 53).

In the various figures, identical or similar elements bear the same references. Given the symmetry of the tread, in order for the figures to be readable, the elements are referenced once sometimes on the side 20G and sometimes on the side 20D.

FIG. 1 shows a tread pattern half-element referenced 1-A and three cross-sectional views: the cross-sectional view EE lying on a section plane in the portion Z3, FF lying on a section plane in the portion Z2, and lastly a cross-sectional view GG lying on a section plane in the portion Z1.

The tread pattern half-element MA1 is curved from an axial end of one edge 24G of the tread to the centre (C) of the tread. The concavity of the half-element, which is oriented towards the centre of the tread (C), determines the running direction of the tyre, indicated by the reference 25. The tread pattern half-element MA1 comprises a sipe 80, which extends axially from one edge (24G, 24D) to the end of MA1 at the centre of the tread.

The half-element MA1 comprises three portions, a portion (Z3) contiguous with the edge 24G of the tread with an axial width of around one third of the total axial width of the half-element, a central portion (Z1) with the same axial width as the portion (Z3), and an intermediate portion (Z2) contiguous with the two other portions.

Each portion (Z1, Z2, Z3) is volumetric element having a leading face which is the face of which the radially outer edge corner is the first to enter the contact patch in which the tyre is in contact with the ground. The edge corner of the radially outer leading face is referred to as leading edge corner below.

Each portion (Z1, Z2, Z3) is finally provided with a chamfered edge corner, these being respectively referenced (51, 52, 53). The chamfers of the three portions (Z1, Z2, Z3) are shown in the cross sections EE, FF and GG. These chamfers (51, 52, 53) are delimited by the leading face 22 and the tread surface 20. The width of a chamfer (51, 52, 53) of a portion is the normal distance between the trailing face and the edge corner of the chamfer belonging to the tread surface. By way of illustration, the width LC₃^{A} represents the width of the chamfer of the element MA in the central portion Z3.

FIG. 2 shows a complete tread pattern element MA comprising two half-elements (MA1, MA2) that are symmetric with respect to the equatorial plane (“C”) and are offset in the circumferential direction by a length D. The repetition per wheel revolution of the tread pattern element MA formed of the half-elements (MA1, MA2) results in a tread referred to as a directional tread. The presence of a single tread pattern element MA means that the tread is a mono-pitch tread.

FIG. 3 shows a first embodiment of the invention with a circumferential developed view of the tread 10 of the tyre, which comprises two rows 20G and 20D of half-elements that are symmetric with respect to the equatorial plane C and offset in the circumferential direction by a distance D. The tread pattern elements are separated at least in part by grooves 30 and extend radially towards the outside from a bottom surface 40 to the tread surface 20 over a radial height H.

Each element (MA, MB) is made up of two half-elements (MA1, MA2) and (MB1, MB2) that are symmetric with respect to the equatorial plane C such that the element extends axially from a first edge 24G to a second edge 24D over an axial width W. A distribution pitch PA (and, respectively, PB) is associated with the element MA (and, respectively, MB). The pitch of an element is the distance measured around a circumference of the tread surface between a point of this element and the translated image of this point onto the immediately following element. The leading edge corners of each portion (Z1, Z2, Z3) of each element (MA, MB) of the tread pattern are chamfered. The chamfers are respectively referenced (51, 52, 53) with associated widths (LC₁^{A}, LC₂^{A}, LC₃^{A}) for the element MA and (LC₁^{B}, LC₂^{B}, LC₃^{B}) for the element MB.

The “edges” 24G, 24D of the tread 10 are understood to be the surfaces that limit the boundaries between the tread 10 and the sidewalls 60. These two edges 24G, 24D are at a distance from one another by a value W corresponding to the width of the tread 10. These two edges 24D, 24G are situated at equal distances from a central axis C. This central axis C divides the tread 10 into two half-treads.

Still in FIG. 3, the tread pattern of the tread comprises an element MA, depicted with vertical hatching and an element MB depicted with small waves. The number of tread pattern elements distributed in the circumferential direction results from the minimization of the running noise emitted by the tyre depending on the geometry of the elements (width, pitch, cuts, etc.). The tread depicted in FIG. 3 is referred to as a multi-pitch tread with two tread pattern elements MA and MB with respective pitches PA and PB. Each half-element (MA1, MA2) and (MB1, MB2) of the tread pattern elements (MA, MB) comprises a sipe 80 which extends from one edge (24G, 24G) to the end of the half-element at the centre of the tread.

FIG. 4 shows a second embodiment of the invention, in which the tread pattern of the tread comprises a third tread pattern element MC. Here again, the element MC comprises two half-elements (MC1, MC2) that are symmetric with respect to the equatorial plane C. This third element is depicted with graphical elements in the form of dots on a white background. The pitch associated with this element is PC. The half-elements of MC likewise comprise a sipe 80. FIG. 4 differs from FIG. 3 through the addition of the additional element MC with a pitch PC.

FIG. 5 is a third embodiment of the invention. It differs from FIG. 4 in that both the trailing and leading edge corners are chamfered. The chamfers of the trailing edge corners are referenced (61, 62, 63).

FIG. 6 is an enlargement of a tread pattern element of the third embodiment of the invention, in which the leading edge corners (51, 52, 53) and trailing edge corners (61, 62, 63) are chamfered in the zones (Z1, Z2, Z3). The chamfers of the trailing edge corners have widths (KC₁^{A}, KC₂^{A}, KC₃^{A}) which do not necessarily have the same values as the widths of the chamfers of the leading edge corners.

FIG. 7 shows the footprint on the ground of a tyre of the invention inflated to its nominal pressure and subjected to a vertical load. The perimeter of the contact patch is indicated by the broken-line curve. Inside this perimeter, the geometric elements with a light background represent the voids of the tread pattern of the tread, grooves 30 and sipes 80, and the geometric elements on a dark background represent the material surface in contact with the ground, made up of the tread pattern elements. The tyre compressed by the load has its deformed tread pattern extending from an edge 24G to an edge 24D over a width W.

FIG. 8 is an extract from FIG. 7 centred on a tread pattern element in the contact patch with the leading edge corners chamfered (51, 52, 53). The half-elements (MA1, MA2) comprise sipes 80 running from the edge (24G, 24D) to the ends of (MA1, MA2). This figure illustrates the calculation of the sipes density. The projection of the sipe 80 of the half-element MA1 onto the axial direction is Lpy1, and the projection of the sipe 80 of the half-element MA2 onto the axial direction is Lpy2. By definition, the sipes density SDA, according to FIG. 8, is the ratio 1000*(LPy1+LPy2)/(PA*W).

The invention was studied more particularly in the case of a passenger vehicle tyre of standardized designation, according to the ETRTO (European Tyre and Rim Technical Organisation), 205/65 R16 94V. For this size, a version according to the invention with three tread pattern elements MA, MB and MC, with respective variable pitches PA, PB and PC, was produced.

To optimize the arrangement of the elements so as to reduce the whining and beating noise, each tread pattern element is associated with an elementary, for example sinusoidal, signal. For one complete revolution of the wheel, the associated signal is periodic and results from the sum of the elementary signals.

With the aid of a digital tool, the initial arrangement is optimized with respect to the whining and beating noise by carrying out simulations on different arrangements. Using a Fourier transform on the signal associated with the arrangement, the spectrum of the signal is analysed in the frequency domain. The criteria for stopping the optimization process are linked to the amplitude of the whining and beating features, and to their spread along the frequency axis.

At the end of this iterative approach, for the tyre size studied, 205/65R16 94V, the total number of elements of the tread is established at 73 per wheel revolution, arranged in the sequence: MB-MC-MC-MC-MA-MC-MB-MB-MA-MB-MA-MB-MC-MA-MA-MA-MA-MA-MA-MB-MC-MC-MB-MA-MA-MC-MB-MC-MA-MC-MB-MA-MA-MB-MB-MB-MC-MC-MA-MA-MA-MA-MB-MB-MB-MC-MC-MC-MB-MB-MA-MA-MA-MB-MA-MC-MA-MB-MA-MC-MA-MC-MC-MB-MB-MA-MA-MA-MA-MA-MB-MB-MC.

The circumference of the tyre is equal to 2017.5 mm and the width of the tread is 161 mm. The tread pattern of the tread of the manufactured tyre comprises 3 tread pattern elements (MA, MB, MC) which are distributed in 30 elements MA, in 18 elements MB and finally in 15 elements MC.

The following table recaps the features of the tread pattern elements (MA, MB, MC):

TABLE 1

| | | Nominal width of | | | Volumetric | |
|---|---|---|---|---|---|---|
| | Number | the elements (mm) | | | void ratio | Pitch |
| | of tread | Cen- | Inter- | | of the | of the |
| | pattern | tre | mediate | Edge | elements | elements |
| | elements | Z1 | Z2 | Z3 | (%) | (mm) |
| Elements | 30 | 3.9 | 7.1 | 8.1 | 30.5 | 23.56 |
| MA | | | | | | |
| Elements | 18 | 4.6 | 8.3 | 9.6 | 30.5 | 27.71 |
| MB | | | | | | |
| Elements | 15 | 5.6 | 10.1 | 11.4 | 30.5 | 33.66 |
| MC | | | | | | |

Each tread pattern element (MA, MB, MC) is formed of two half-elements (MA1, MA2), (MB1, MB2) and (MC1, MC2). The data in Table 1 are consolidated for the complete tread pattern element (MA, MB, MC) cumulating the contributions of the two half-elements as regards the void ratios.

Each tread pattern half-element is cut into three portions (Z1, Z2, Z3). The mean normal width of each portion is measured by measuring the normal distance between the leading and trailing edge corners without taking the chamfers into account.

The average of the sipes densities of the tread pattern elements (MA, MB, MC) per wheel revolution is 36 mm⁻¹. This is the weighted average of the sipes densities of each of the tread pattern elements. For example, the sipes density of the tread pattern element MB is 36 mm⁻¹.

The surface void ratio is 48.6±0.02. Its value increases by 8% with the presence of the chamfers at the trailing edge corners (15% with the trailing and leading edge corners). Under these conditions, the performance is improved by the effect of contact pressure on the trailing edge corners.

The volumetric void ratio is 30.5%±0.004, making it possible to ensure a sufficient performance on wet ground for an “all-season” tyre. The following table summarizes the characteristics of the chamfers:

TABLE 2

| | Chamfer width | Chamfer width | Chamfer width |
|---|---|---|---|
| | in the edge | in the centre | in the intermediate |
| | portion (Z1) | portion (Z3) | portion (Z2) |
| | mm | mm | mm |
| Elements MA | 1.3 | 0.85 | 1.7 |
| Elements MB | 1.5 | 1 | 2 |
| Elements MC | 1.8 | 1.2 | 2.4 |

The width of a chamfer in a portion (Z1, Z2, Z3) is the normal distance between the trailing face of the portion and the edge corner of the chamfer belonging to the tread surface.

The presence of the chamfers on the leading edges of the tread pattern elements improves grip on snow by around 3 to 5%.

The presence of the chamfers on the leading edges of the tread pattern elements does not have a detrimental effect on the running noise, which remains in accordance with UNECE (United Nations Economic Commission for Europe) regulation R117 with a level of radiated acoustic power below the threshold provided by the regulation.

The invention is not limited to the embodiments and variants presented and other embodiments and variants will become clearly apparent to a person skilled in the art.

1.-14. (canceled)

15. A tire having a tread (10) intended to come into contact with the ground via a tread surface (20), the tread (10) comprising raised elements that are organized in tread pattern elements (MA, MB), are separated from one another at least in part by grooves (30) and extend radially toward the outside from a bottom surface (40) as far as the tread surface (20) over a radial height H at least equal to 6 mm and at most equal to a radial height Hₘₐₓ of the tread (10),
each tread pattern element (MA, MB) comprising two half-elements (MA1, MA2) and (MB1, MB2), which are symmetric with respect to an equatorial plane passing through the center of the tread (C) and are offset from one another in the circumferential direction by a distance D,
each half-element (MA1, MB1) and its respective symmetric counterpart (MA2, MB2) being curved, in an axial direction (YY′), from an axial end of one edge (24G, 24D) of the tread to the center (C) of the tread (10) so as to define a preferred direction of running of the tire, and having an axial width (L),
each half-element (MA1, MB1; MA2, MB2) comprising a first, lateral portion (Z3) extending from an axial end of the edge (24G, 24D) of the tread over an axial width equal to at most one third of the axial width (L) of the half-element, a second, central portion (Z1) having the same axial width as the first, lateral portion (Z3), and a third, intermediate portion (Z2) contiguous with the two other portions,
each portion (Z1, Z2, Z3) of each half-element (MA1, MB1; MA2, MB2) being a volumetric element having a leading face, which is the face of which the radially outer edge corner is the first to enter the contact patch in which the tire is in contact with the ground, the edge corner of the radially outer leading face being the leading edge corner,
each portion (Z1, Z2, Z3) of each half-element (MA1, MB1; MA2, MB2) having a trailing face, which is the face of which the radially outer edge corner is the last to leave the contact patch in which the tire is in contact with the ground, the edge corner of the radially outer trailing face being the trailing edge corner,
the leading edge corners of each portion (Z1, Z2, Z3) respectively having a chamfered profile (51, 52, 53), with respective widths of the chamfers (LC₁^{A}, LC₂^{A}, LC₃^{A}) for the half-elements (MA1, MA2) of a first element and, respectively, (LC₁^{B}, LC₂^{B}, LC₃^{B}) for the half-elements (MB1, MB2) of a second element,
the width of a chamfer in a portion (Z1, Z2, Z3) being a normal distance between the leading face of the portion and the edge corner of the chamfer belonging to the tread surface,
the tread being obtained through a periodic distribution in the circumferential direction of a first tread pattern element MA formed of the first half element MA1 and of its symmetric counterpart MA2 at a pitch PA, and of a second tread pattern element MB formed of the second half element MB1 and of its symmetric counterpart MB2 at a pitch PB, where PA<PB,
a sipe being a cut or void in which a distance between walls of material that delimit the sipe is less than or equal to 2 mm and a depth of which is greater than or equal to 1 mm, the sipes density of the tread pattern elements SD corresponding to a ratio between a sum of projected lengths (lpyi) of the sipes of a tread pattern element (MA, MB) along an axial direction (Y) to a product of the pitch (PA, PB) of the tread pattern element and the width (W) of the tread, the whole being multiplied by 1000, such that
$$SDA = \frac{{\sum }_{i = 1}^{nay} lpyi}{PA * W} * 1000 , and SDB = \frac{{\sum }_{i = 1}^{nby} lpyi}{PB * W} * 1000$$
where nay and nby are a number of sipes of each tread pattern element (MA, MB) and lpyi is a projected length of the i-th sipe of a given element,
wherein, in the portions Z1 and/or Z2, and/or Z3, the widths of the chamfers of the leading edge corners (LCᵢ^{A}, LCᵢ^{B}, i ranging from 1 to 3) of the half-elements (MA1, MA2) and (MB1, MB2) with respective pitches (PA, PB) satisfy the following inequalities:
a) for the portion Z1:
$$0.8 * \frac{PA}{PB} \leq \frac{{LC}_{1}^{A}}{{LC}_{1}^{B}} \leq \frac{PA}{PB} * 1.2$$
b) for the portion Z2:
$$0.8 * \frac{PA}{PB} \leq \frac{{LC}_{2}^{A}}{{LC}_{2}^{B}} \leq \frac{PA}{PB} * 1.2 ,$$
and
c) for the portion Z3:
$$0 , 8 * \frac{PA}{PB} \leq \frac{{LC}_{3}^{A}}{{LC}_{3}^{B}} \leq \frac{PA}{PB} * 1 , 2 ,$$
and
wherein the sipes density of each tread pattern element (SDA, SDB) is at least equal to 10 mm⁻¹ and at most equal to 70 mm⁻¹.

16. The tire according to claim 15, wherein the tread comprises a number (NA, NB) of tread pattern elements (MA, MB), an average sipes density SDmoy being at least equal to 10 mm⁻¹ and at most equal to 70 mm⁻¹, with the average sipes density being defined by:
$$SDmoy = \frac{SDA * NA * PA + SDB * NB * PB}{NA * PA + NB * PB} ,$$
where (SDA, SDB) are sipe densities of the tread pattern elements (MA, MB).

17. The tire according to claim 15, wherein a ratio between the pitch PA of the first tread pattern element MA formed of the half-elements (MA1, MA2) divided by the pitch PB of the second tread pattern element MB formed of the half-elements (MB1, MB2), PA/PB is at least equal to 0.60 and at most equal to 0.90.

18. The tire according to claim 15, wherein a ratio between the pitch PA of the first tread pattern element MA formed of the half-elements (MA1, MA2) divided by the pitch PB of the second tread pattern element MB formed of the half-elements (MB1, MB2), PA/PB is at least equal to 0.85.

19. The tire according to claim 15, wherein the widths of the chamfers of the leading edge corners (LC₁^{A}, LC₂^{A}, LC₃^{A}) for the first tread pattern element MA formed of the half-elements (MA1, MA2) and (LC₁^{B}, LC₂^{B}, LC₃^{B}) for the second tread pattern element MB formed of the second half-elements (MB1, MB2) of the respective portions (Z1, Z2, Z3) satisfy at least one of the following relationships:
LC₁^{x} belongs to the range [0.5, 2] mm, where X=A, or B,
LC₂^{x} belongs to the range [1, 2.5] mm, where X=A or B, and
LC₃^{x} belongs to the range [1.5, 3] mm, where X=A, or B.

20. The tire according to claim 15, the tread further comprising a third tread pattern element MC formed of two tread pattern half-elements (MC1, MC2) that are symmetric with respect to the equatorial plane (C), with a pitch PC, where PB is smaller than PC, wherein a ratio of the pitches PB/PC is greater than or equal to a ratio of the pitches PA/PB.

21. The tire according to claim 15, wherein the tread pattern elements have a radial height Hₘₐₓ at most equal to 9 mm.

22. The tire according to claim 15, the overall volumetric void ratio TEV corresponding to a ratio of a void volume VE to a total volume VT of the tread, such that TEV=VE/VT, wherein the volumetric void ratio TEV of the tread is between 20% and 40%.

23. The tire according to claim 20, the tread comprising a third tread pattern element MC with a pitch PC, wherein the volumetric void ratio TEM of each tread pattern element (MA, MB, MC) is more or less identical.

24. The tire according to claim 20, the tread comprising a third tread pattern element MC with a pitch PC, wherein a maximum pitch of the tread pattern elements out of the pitch (PA) of the first element (MA), the pitch (PB) of the second element (MB) and the pitch (PC) of the third element (MC) is between 22 mm and 40 mm.

25. The tire according to claim 15, wherein a composition of a rubbery material of the tread has a glass transition temperature Tg of between −40° C. and −10° C. and a complex dynamic shear modulus G* measured at 60° C. of between 0.5 MPa and 2 MPa.

26. The tire according to claim 15, wherein at least 30% of the leading and/or trailing edge corners have a chamfer.

27. The tire according to claim 20, the tread comprising a number (NA, NB, NC) of tread pattern elements (MA, MB, MC), the average sipes density SDmoy being at least equal to 10 mm⁻¹ and at most equal to 70 mm⁻¹, with the average sipes density being defined by:
$$SDmoy = \frac{SDA * NA * PA + SDB * NB * PB + SDC * NC * PC}{NA * PA + NB * PB + NC * PC} ,$$
where SDC is the sipes density of the element MC of the tread pattern.

28. The tire according to claim 15, wherein the tire has a 3PMSF (3 Peaks Mountain Snow Flake) winter certification indicated on at least one of its sidewalls.
